(19) United States
(12) Patent Application Publication
(10) Pub. No.: US 2018/0338501 A1
(43) Pub. Date: Nov. 29, 2018

(54) SPOILAGE RETARDANT COMPOSITIONS FOR TREATMENT OF CROPS

(71) Applicant: BOTANOCAP LTD., Ganei Tikva (IL)

(72) Inventors: Avishay PELAH, Kiryat-Ono (IL); Yigal GEZUNDHAIT, Ganey Tikva (IL); Rafael ISCHAKOV, Kiryat Gat (IL)

(73) Assignee: BOTANOCAP LTD., Ganei Tikva (IL)

(21) Appl. No.: 15/768,332

(22) PCT Filed: Oct. 10, 2016
(86) PCT No.: PCT/IL2016/051099

§ 371 Date: Apr. 13, 2018

Related U.S. Application Data
(60) Provisional application No. 62/240,540, filed on Oct. 13, 2015.

(51) Int. Cl. A01N 65/00; A01N 65/42; A01N 25/12; A01N 65/22

(52) U.S. Cl. CPC A01N 65/00; A01N 65/22; A01N 25/12; A01N 65/42

(57) ABSTRACT

Provided is a microcapsule including a wax encapsulating an essential oil. As provided, the wax may be a naturally occurring wax having a melting point above 60° C., the microcapsule may comprises 5-25% by weight of the essential oil, the microcapsule may have an average diameter of 5-1000 microns, and the microcapsule may be a matrix type microcapsule in which the essential oil is distributed uniformly within the wax.

### FIELD OF THE INVENTION

The present invention provides microcapsules including a natural wax encapsulating essential oils, preferably tea tree oil, useful for spoilage retardation of post-harvest crops.

### BACKGROUND OF THE INVENTION

Storage of grapes is often compromised by fungal infections of the grapes particularly gray mold (Botrytis cinerea), leading to postharvest decay.

Chemical inhibitors have been utilized with success for over two decades to prevent spoilage of crop. However, use of chemical inhibitors is often hazardous to the health of the consumer, and the requirement for non-toxic substitutes is becoming prevalent.

Encapsulation forming a barrier between an active ingredient and the environment has become widespread. The barrier serves to protect the active ingredient from degradation caused for example by oxygen, water, or light as well as to obtain a suitable release profile.

European Patent Application No. 2737799 to Stepan et al. discloses solid lipid nanoparticles with high specific surface, consisting of a hydrogenated vegetable oil or wax shell which protects a liquid core consisting of essential oils and allows biopesticides from the core to be released in a controlled manner in the application environment.

U.S. 2014/0335140 to Hoag et al. discloses a composition and method for controlled release of natural plant oils (essential oils) from a wax matrix to repel insects, arachnids, and other arthropods.

US 2001/0055573 to Deblasi et al. discloses methods of making delivery systems for active ingredients including hydrogenated jojoba and sunscreen actives.

U.S. Pat. No. 5,085,868 to Mattson et al. discloses a dosage form for oral administration of a pharmaceutically active substance characterized in that it includes an encapsulated or embedded pharmaceutically active substance in a pharmaceutically acceptable non-aqueous liquid.

U.S. Pat. No. 7,442,439 to Joseph et al. discloses microencapsulated delivery vehicles comprising an active agent. In one embodiment, the microencapsulated delivery vehicles are heat delivery vehicles capable of generating heat upon activation. The microencapsulated heat delivery vehicles may be introduced into wet wipes such that, upon activation, the wet wipe solution is warmed resulting in a warm sensation on a user's skin. Any number of other active ingredients, such as cooling agents and biocides, can also be incorporated into a microencapsulated delivery vehicle.

Recently encapsulation using a melt dispersion technique has been utilized for encapsulation of certain flavor enhancers. The techniques is based on emulsification of a molten mass in an aqueous phase followed by solidification based on chilling (Milanovic et al., Sensors 10, 901-912 (2010), Milanovic et al., Chemical Papers 65 (2) 213-220 (2011)). This process has been used for encapsulation of ethyl vanillin flavor and showed satisfying release kinetics, however encapsulation of other compounds such as coconut flavor proved less efficient.

There thus remains a need for microcapsules suitable for encapsulation of essentials oils, preferably made of GRAS components only, having a satisfactory release profile and a low cost of production.

### SUMMARY OF THE INVENTION

Aspects of the disclosure, in some embodiments thereof, relate to microcapsules the microcapsules including a wax encapsulating essential oils, particularly tea tree oil.

Advantageously, the encapsulation process is based on emulsifying the essential oil in a solution containing melted wax. In comparison to other encapsulation techniques, the process is relatively simple, economically reasonable and easy to scale-up.

As a further advantage, the microcapsule is preferably made of GRAS components only, and is thus particularly suitable for post-harvest treatment of vegetables and fruits.

It is now disclosed for the first time that the microcapsules comprising a wax that is solid at room temperature, for encapsulating essential oils surprisingly provide a sustained release profile suitable for long-term applications. In some embodiments, about 20% to 90% of the essential oil is retained in the microcapsule for 3 weeks after application to a substrate. In some embodiments, about 20% to 90% of the essential oil is retained in the microcapsule for 3 weeks after application to a substrate. In some embodiments, about 30% to 95% of the essential oil is retained in the microcapsule for 3 weeks after application to a substrate. According to some embodiments, 40% to 85% of the at least one essential oil is retained in the microcapsule for 3 weeks after application to a substrate. According to some embodiments, 50% to 85% of the at least one essential oil is retained in the microcapsule for 3 weeks after application to a substrate.

It is now disclosed that the microcapsules comprising wax encapsulating essential oils are advantageous for inhibiting fungal infections of grapes.

According to some embodiments, there is provided a microcapsule comprising a wax encapsulating an essential oil; wherein the wax is a naturally occurring wax having a melting point above 60° C.; and wherein the microcapsule comprises 10-25% by weight of the essential oil. According to some embodiments, 20% to 90% of the essential oil is retained in the microcapsule for 3 weeks upon exposure to the atmosphere. According to some embodiments, the microcapsule is a matrix type microcapsule.

According to some embodiments, the essential oil is selected from the group consisting of angelica oil, anise oil, basil oil, bay oil, bergamot oil, bois de rose oil, calendula oil cananga oil, caraway oil, cardamom oil, cedar oil, cedarwood oil, chamaecyparis obtusa oil, chamomile oil, cinnamon oil, citronella oil, clary sage oil, clove oil, copaiba balsam oil, coriander oil, cumin oil, dill seed oil, eucalyptus globulus oil, eucalyptus radiate oil, fennel oil, garlic oil, geranium oil, ginger oil, grapefruit oil, guaiacwood oil, hiba oil, ho camphor oil, iris oil, Japanese mint oil, jasmine oil, lavender oil, laurel leaf oil, lemon oil, lemongrass oil, lime oil, linaloe oil, lindera oil, marjoram oil, mandarin peel oil, mustard oil, neroli oil, niaouli oil, onion oil, orange oil, oregano oil, palmarosa oil, parsley oil, patchouli oil, peach kernel oil, pennyroyal oil, pepper oil, peppermint oil, perilla oil, Peru balsam oil, petitgrain oil, pine needle oil, rose oil, rosemary oil, sandalwood oil, spearmint oil, star anis oil, tagetes oil, tea tree oil, tea seed oil, thyme oil, tolu balsam oil, tuberose oil, turmeric oil, vetivert oil, western mint oil, white micromeria oil, wintergreen oil, combinations and/or derivatives thereof. Each possibility is a separate embodiment. According to some embodiments, the essential oil is tea tree oil.

According to some embodiments, the microcapsule comprises 5-25% by weight of the essential oil. According to some embodiments, the microcapsule comprises 12-25% by weight of the essential oil. According to some embodiments, the microcapsule comprises 15-25% by weight of the essential oil comprises. According to some embodiments, the microcapsule comprises 15-50% by weight of the essential oil.

According to some embodiments, the natural wax is selected from the group consisting of carnauba wax, candelilla wax, beeswax, cocoa butter, montan (also known as lignite wax) wax, rice bran wax, sugar cane wax and any combination thereof. According to some embodiments, the natural wax is carnauba wax. According to some embodiments, the wax is montan wax. According to some embodiments, the wax is devoid of chemical modifications and/or treatment.

According to some embodiments, the microcapsule further comprises a surfactant selected from the group consisting of glyceryl monostearate, polyoxyethylene monooleate, polyoxyethylene monolaurate, polyoxyethylene sorbitan monolaurate, polyoxyethylene sorbitan monopalmitate, polyoxyethylene sorbitan monostearate, polyoxyethylene sorbitan tristearate, polyoxyethylene sorbitan monooleate, polyoxyethylene sorbitan trioleate, potassium oleate, polysorbate 20, polysorbate 40, polysorbate 80, sodium lauryl sulfate, sodium oleate, sorbitan monopalmitate, sorbitan monooleate, sorbitan monostearate, sorbitan tristearate, sorbitan trioleate, sorbitan monolaurate, triethanolamine oleate, and any combination thereof. Each possibility is a separate embodiment.

According to some embodiments, the microcapsule comprises 0.1-0.5% by weight of the surfactant.

According to some embodiments, the microcapsule has an average diameter of 5-1000 microns. According to some embodiments, the microcapsule has an average diameter of 100-300 microns. According to some embodiments, the microcapsule has an average diameter of above 300 microns.

According to some embodiments, 40% to 75% of the essential oil is retained in the microcapsule for 3 weeks after application to a substrate.

According to some embodiments, the microcapsule is capable of inhibiting decay of grapes.

According to some embodiments, there is provided a method for inhibiting decay of grapes, the method comprising exposing grapes to a plurality of microcapsules comprising a wax encapsulating an essential oil, wherein the wax is a naturally occurring wax having a melting point above 60° C.; and wherein the microcapsule comprises 10-25% by weight of the essential oil. According to some embodiments, 20% to 95% of the essential oil is retained in the microcapsule for 3 weeks upon exposure to the atmosphere. According to some embodiments, the microcapsule is a matrix type microcapsule.

According to some embodiments, inhibiting the decay of grapes comprises inhibiting fungal infection of the grapes, in particular fungal infections caused by gray mold (Botrytis cinerea). According to some embodiments, the decay of the grapes is inhibited by at least 60%, 70%, 80% or 90%, when stored at 6-8° C. for three weeks. Each possibility is a separate embodiment.

According to some embodiments, the essential oil is selected from the group consisting of angelica oil, anise oil, basil oil, bay oil, bergamot oil, bois de rose oil, calendula oil cananga oil, caraway oil, cardamom oil, cedar oil, cedarwood oil, chamaecyparis obtusa oil, chamomile oil, cinnamon oil, citronella oil, clary sage oil, clove oil, copaiba balsam oil, coriander oil, cumin oil, dill seed oil, eucalyptus globulus oil, eucalyptus radiate oil, fennel oil, garlic oil, geranium oil, ginger oil, grapefruit oil, guaiacwood oil, hiba oil, ho camphor oil, iris oil, Japanese mint oil, jasmine oil, lavender oil, laurel leaf oil, lemon oil, lemongrass oil, lime oil, linaloe oil, lindera oil, marjoram oil, mandarin peel oil, mustard oil, neroli oil, niaouli oil, onion oil, orange oil, oregano oil, palmarosa oil, parsley oil, patchouli oil, peach kernel oil, pennyroyal oil, pepper oil, peppermint oil, perilla oil, Peru balsam oil, petitgrain oil, pine needle oil, rose oil, rosemary oil, sandalwood oil, spearmint oil, star anis oil, tagetes oil, tea tree oil, tea seed oil, thyme oil, tolu balsam oil, tuberose oil, turmeric oil, vetivert oil, western mint oil, white micromeria oil, wintergreen oil, combinations and/or derivatives thereof. Each possibility is a separate embodiment. According to some embodiments, the essential oil is tea tree oil.

According to some embodiments, the microcapsule comprises 5-25% by weight of the essential oil. According to some embodiments, the microcapsule comprises 12-25% by weight of the essential oil. According to some embodiments, the microcapsule comprises 15-25% by weight of the essential oil. According to some embodiments, the microcapsule comprises 15-50% by weight of the essential oil.

According to some embodiments, the natural wax is selected from the group consisting of carnauba wax, candelilla wax, beeswax, cocoa butter, montan wax, rice bran wax, sugar cane wax and any combination thereof. According to some embodiments, the natural wax is carnauba wax. According to some embodiments, the wax is montane wax. According to some embodiments, the wax is devoid of chemical modifications and/or treatment.

According to some embodiments, the microcapsule further comprises a surfactant selected from the group consisting of glyceryl monostearate, polyoxyethylene monooleate, polyoxyethylene monolaurate, polyoxyethylene sorbitan monolaurate, polyoxyethylene sorbitan monopalmitate, polyoxyethylene sorbitan monostearate, polyoxyethylene sorbitan tristearate, polyoxyethylene sorbitan monooleate, polyoxyethylene sorbitan trioleate, potassium oleate, polysorbate 20, polysorbate 40, polysorbate 80, sodium lauryl sulfate, sodium oleate, sorbitan monopalmitate, sorbitan monooleate, sorbitan monostearate, sorbitan tristearate, sorbitan trioleate, sorbitan monolaurate, triethanolamine oleate, and any combination thereof. Each possibility is a separate embodiment.

According to some embodiments, the microcapsule comprises 0.1-0.5% by weight of the surfactant.

According to some embodiments, the microcapsule has an average diameter of 5-1000 microns. According to some embodiments, the microcapsule has an average diameter of 10-500 microns. According to some embodiments, the microcapsule has an average diameter of 100-300 microns. According to some embodiments, the microcapsule has an average diameter of above 300 microns.

According to some embodiments, 40% to 75% of the essential oil is retained in the microcapsule for 3 weeks after application to a substrate.

According to some embodiments, there is provided a sachet sealed in an airtight package comprising a plurality of microcapsules comprising a wax encapsulating an essential oil, wherein the wax is a naturally occurring wax having a melting point above 60° C.; and wherein and wherein the microcapsule comprises 10-25% by weight of the essential oil, as essentially described herein. According to some embodiments, about 20% to 90% of the essential oil is retained in the microcapsule for 3 weeks after application to a substrate. According to some embodiments, 30% to 95% of the essential oil is retained in the microcapsule for 3 weeks after unsealing of the sachet. According to some embodiments, 40% to 85% of the essential oil is retained in the microcapsule for 3 weeks after unsealing of the sachet. According to some embodiments, 50% to 85% of the essential oil is retained in the microcapsule for 3 weeks after unsealing of the sachet. According to some embodiments, the microcapsule is a matrix type microcapsule.

According to some embodiments, the essential oil is selected from the group consisting of angelica oil, anise oil, basil oil, bay oil, bergamot oil, bois de rose oil, calendula oil cananga oil, caraway oil, cardamom oil, cedar oil, cedarwood oil, chamaecyparis obtusa oil, chamomile oil, cinnamon oil, citronella oil, clary sage oil, clove oil, copaiba balsam oil, coriander oil, cumin oil, dill seed oil, eucalyptus globulus oil, eucalyptus radiate oil, fennel oil, garlic oil, geranium oil, ginger oil, grapefruit oil, guaiacwood oil, hiba oil, ho camphor oil, iris oil, Japanese mint oil, jasmine oil, lavender oil, laurel leaf oil, lemon oil, lemongrass oil, lime oil, linaloe oil, lindera oil, marjoram oil, mandarin peel oil, mustard oil, neroli oil, niaouli oil, onion oil, orange oil, oregano oil, palmarosa oil, parsley oil, patchouli oil, peach kernel oil, pennyroyal oil, pepper oil, peppermint oil, perilla oil, Peru balsam oil, petitgrain oil, pine needle oil, rose oil, rosemary oil, sandalwood oil, spearmint oil, star anis oil, tagetes oil, tea tree oil, tea seed oil, thyme oil, tolu balsam oil, tuberose oil, turmeric oil, vetivert oil, western mint oil, white micromeria oil, wintergreen oil, combinations and/or derivatives thereof. Each possibility is a separate embodiment. According to some embodiments, the essential oil is tea tree oil.

According to some embodiments, the microcapsule comprises 5-25% by weight of the essential oil. According to some embodiments, the microcapsule comprises 12-25% by weight of the essential oil. According to some embodiments, the microcapsule comprises 15-25% by weight of the essential oil com. According to some embodiments, the microcapsule comprises 15-50% by weight of the essential oil.

According to some embodiments, the natural wax is selected from the group consisting of carnauba wax, candelilla wax, beeswax, cocoa butter, montan wax, rice bran wax, sugar cane wax and any combination thereof. According to some embodiments, the natural wax is carnauba wax. According to some embodiments, the wax is montane wax. According to some embodiments, the wax is devoid of chemical modifications and/or treatment.

According to some embodiments, the microcapsule further comprises a surfactant selected from the group consisting of glyceryl monostearate, polyoxyethylene monooleate, polyoxyethylene monolaurate, polyoxyethylene sorbitan monolaurate, polyoxyethylene sorbitan monopalmitate, polyoxyethylene sorbitan monostearate, polyoxyethylene sorbitan tristearate, polyoxyethylene sorbitan monooleate, polyoxyethylene sorbitan trioleate, potassium oleate, polysorbate 20, polysorbate 40, polysorbate 80, sodium lauryl sulfate, sodium oleate, sorbitan monopalmitate, sorbitan monooleate, sorbitan monostearate, sorbitan tristearate, sorbitan trioleate, sorbitan monolaurate, triethanolamine oleate, and any combination thereof. Each possibility is a separate embodiment.

According to some embodiments, the microcapsule comprises 0.1-0.5% by weight of the surfactant.

According to some embodiments, the microcapsule has an average diameter of 5-300 microns. According to some embodiments, the microcapsule has an average diameter of 10-500 microns. According to some embodiments, the microcapsule has an average diameter of 100-300 microns. According to some embodiments, the microcapsule has an average diameter of above 300 microns.

According to some embodiments, 40% to 75% of the essential oil is retained in the microcapsule for 3 weeks after application to a substrate.

According to some embodiments, there is provided a sealed sachet comprising a plurality of microcapsules, the microcapsules comprising a wax encapsulating an essential oil, wherein the wax is a naturally occurring wax having a melting point above 60° C.; and wherein the microcapsule comprises 10-25% by weight of the essential oil. According to some embodiments, 20% to 90% of the essential oil is retained in the microcapsule for 3 weeks after unsealing of the sachet. According to some embodiments, 40% to 90% of the essential oil is retained in the microcapsule for 3 weeks after unsealing of the sachet. According to some embodiments, the microcapsule is a matrix type microcapsule. According to some embodiments, the essential oil comprises tea tree oil

Further embodiments, features, advantages and the full scope of applicability of the present invention will become apparent from the detailed description given hereinafter. However, it should be understood that the detailed description, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

FIG. 1 schematically illustrates a container with pockets in the sidewalls thereof, according to some embodiments.

FIG. 2 shows a representative release profile of caraway oil from the microcapsules disclosed herein, as compared to a non-encapsulated control.

FIG. 3 shows representative photos of grapes stored for three weeks at 6-8° C. with sachets containing microcapsules of carnauba wax encapsulated tea tree oil (Treated—tea tree oil), grapes stored for three weeks at 6-8° C. with sachets containing microcapsules of carnauba wax encapsulated caraway oil (Treated—caraway oil), grapes stored for three weeks at 6-8° C. with SO₂ impregnated pads (Control—SO₂) or left untreated (Untreated).

### DETAILED DESCRIPTION

There is provided according to some embodiments, a microcapsule or a microparticle comprising a wax encapsulating and/or containing an essential oil. According to some embodiments, the microcapsule consists essentially of a wax encapsulating an essential oil. According to some embodiments, the microcapsule consists essentially of a wax encapsulating an essential oil and a surfactant. According to some embodiments, the microcapsule is a matrix type microcapsule. According to some embodiments, the essential oil is tea tree oil.

As used herein the term “microcapsule” refers to a micro sized capsule or particle having a wax forming a barrier between the encapsulated essential oil and the environment. According to some embodiments, the microcapsule is a microparticle. According to some embodiments, the microcapsule is a bead. According to some embodiments, the microcapsule is a microbead. According to some embodiments, the microcapsule is a microsphere. According to some embodiments, is a matrix type microcapsule. As used herein the term “matrix type microcapsule” refers to microcapsules having a micro-granular structure, in which the active ingredient (e.g. the essential oil) is distributed. According to some embodiments, the distribution of the essential oil in the wax is essentially homogenous/uniform. According to some embodiments, the microcapsule protects the essential oil from oxidation, water, light and other environmental factors harming the stability and/or activity of the essential oil.

According to some embodiments, the microcapsules are devoid of support materials that are used to impart a structure or shape on the matrix comprising the wax. Common examples of such support materials include wood, wood pellets, bamboo pellets, mesh, foam, sponge-like materials, metals, bamboo fibers, wood fibers, strings, ropes, cloths, porous plastic material, solid plastic material, fibrous plastic material, plastic mesh material, pumice, gravel, sand, stone, clay, zeolites, resins, microporous materials, mesoporous materials, granular activated carbon, solid plastic pellets, fabric mesh. Each possibility is a separate embodiment.

According to some embodiments, the microcapsules are in the form of free-flowing beads. According to some embodiments the microcapsules are matrix type microcapsules in which the essential oil is dispersed uniformly within the wax.

According to some embodiments, the microcapsule has an average size of 5-1000 microns, 10-500 microns, 100-300 or any other range within 5-1000 microns. Each possibility is a separate embodiment. According to some embodiments, the microcapsule has an average size of above 300 microns. According to some embodiments, the size distribution of the microcapsules is determined using standard sieve analysis, air elutriation analysis, photoanalysis, optical counting, electroresistance counting methods, sedimentation techniques, laser diffraction, laser obscuration time (LOT), acoustic spectroscopy, dynamic light scattering, static light scattering or any other suitable method for determining particle size. Each possibility is a separate embodiment.

As used herein the term “wax” refers to chemical compounds that are malleable near ambient temperatures.

According to some embodiments, the wax has a melting point above 30° C., above 40° C., above 50° C., above 60° C., or above 70° C. Each possibility is a separate embodiment.

According to some embodiments, the wax is selected from carnauba wax, candelilla wax, beeswax, paraffin wax, microcrystalline wax, cocoa butter, montan wax, rice bran wax, sugar cane wax and any combination thereof. Each possibility is a separate embodiment.

According to some embodiments, the wax is a naturally occurring wax. As used herein, the term “naturally occurring wax” refers to waxes extracted/derived/produced by plants, trees and/or animals. According to some embodiments, the naturally occurring wax is a non-synthetic wax. According to some embodiments, the naturally occurring wax is devoid of chemical modification and/or treatment. According to some embodiments, the naturally occurring wax may be selected from carnauba wax, candelilla wax, beeswax, montan wax, rice bran wax, sugar cane wax and any combination thereof. Each possibility is a separate embodiment. According to some embodiments, the naturally occurring wax is carnauba wax. Additionally or alternatively, the wax is paraffin wax.

According to some embodiments, the microcapsule encapsulates an essential oil. As used herein the term “essential oil” refers to concentrated hydrophobic liquids containing aroma compounds of plants. An oil is essential in the sense that it contains the characteristic fragrance of the plant that it is taken from. Essential oils are volatile and evaporate at room temperature.

According to some embodiments, the microcapsule may encapsulate an essential oil derivative instead of or in addition to the essential oil. Non-limiting examples of essential oil derivatives include allyl isothiocyanate, alpha-terpineol, amyl cinnamic aldehyde, anisic aldehyde, benzaldehyde, benzyl alcohol, benzyl acetate, cinnamaldehyde, cinnamic alcohol, carvacrol, carveol, carvone, citral, citronellal, citronellol, eucalyptol (cineole), eugenol, iso-eugenol, galaxolide, geraniol, guaiacol, hexanal, ionone, d-limonene, menthol, methyl anthranilate, methyl ionone, methyl salicylate, alpha-phellandrene, pennyroyal oil, perillaldehyde, 1- or 2-phenyl ethyl alcohol, 1- or 2-phenyl ethyl propionate, piperonal, piperonyl acetate, piperonyl alcohol, D-pulegone, terpinen-4-ol, terpinyl acetate, 4-tert butylcyclohexyl acetate, thymol, trans-anethole, vanillin, ethyl vanillin, and any combination thereof.

According to some embodiments, the essential oil is selected from the group consisting of angelica oil, anise oil, basil oil, bay oil, bergamot oil, bois de rose oil, calendula oil cananga oil, caraway oil, cardamom oil, cedar oil, cedarwood oil, chamaecyparis obtusa oil, chamomile oil, cinnamon oil, citronella oil, clary sage oil, clove oil, copaiba balsam oil, coriander oil, cumin oil, dill seed oil, eucalyptus globulus oil, eucalyptus radiate oil, fennel oil, garlic oil, geranium oil, ginger oil, grapefruit oil, guaiacwood oil, hiba oil, ho camphor oil, iris oil, Japanese mint oil, jasmine oil, lavender oil, laurel leaf oil, lemon oil, lemongrass oil, lime oil, linaloe oil, lindera oil, marjoram oil, mandarin peel oil, mustard oil, neroli oil, niaouli oil, onion oil, orange oil, oregano oil, palmarosa oil, parsley oil, patchouli oil, peach kernel oil, pennyroyal oil, pepper oil, peppermint oil, perilla oil, Peru balsam oil, petitgrain oil, pine needle oil, rose oil, rosemary oil, sandalwood oil, spearmint oil, star anis oil, tagetes oil, tea tree oil, tea seed oil, thyme oil, tolu balsam oil, tuberose oil, turmeric oil, vetivert oil, western mint oil, white micromeria oil, wintergreen oil, combinations and/or derivatives thereof. Each possibility is a separate embodiment. According to some embodiments, the essential oil is tea tree oil.

According to some embodiments, the microcapsule may further comprise an additional external layer coating the microcapsule. According to some embodiments, the external layer may be a polyurea or a polyurethane film. According to some embodiments, the external layer may be a layer made of a multivalent salt form of an alkanoic acid. According to some embodiments, the external layer may be formed by interfacial polymerization on the microcapsule.

According to some embodiments, each microcapsule may encapsulate a single essential oil. As a non-limiting example, the microcapsule may encapsulate tea tree oil only. According to some embodiments, the microcapsules may encapsulate more than one essential oil, such as 2, 3, 4 or more essential oils. Each possibility is a separate embodiment. As a non-limiting example, the microcapsule may encapsulate caraway oil and tea tree oil.

According to some embodiments, the microcapsule comprises 1-10% w/w of the essential oil, 5-50% w/w of the essential oil, 10-25% w/w of the essential oil, 12-50% w/w of the essential oil, 12-25% w/w of the essential oil 15-50% w/w of the essential oil, 15-25% w/w of the essential oil or 15-75% w/w of the essential oil. Each possibility is a separate embodiment. According to some embodiments, the microcapsule comprises about 10% w/w of the essential oil. According to some embodiments, the microcapsule comprises about 15% w/w of the essential oil. According to some embodiments, the microcapsule comprises about 20% w/w of the essential oil.

According to some embodiments, about 20% to 95%, about 20% to 90%, about 20% to 60%, about 30% to 90%, about 30-% to 80%, about 30% to 60%, about 30% to 50%, about 40% to 90%, about 40-% to 80%, about 40% to 60%, about 40% to 50%, about 50% to 90%, about 50% to 85%, or about 50% to 80%, of the essential oil is retained in the microcapsule for 3 weeks upon exposure to the atmosphere. Each possibility is a separate embodiment. According to some embodiments, about 10% to 50%, about 20% to 90%, about 20% to 80%, about 20% to 50%, about 30% to 90%, about 30% to 80%, about 30% to 50%, about 40% to 90%, about 40% to 80%, about 40% to 75%, about 40% to 50%, or about 50% to 85%, of the essential oil is released from in the microcapsule within 1, 2 or 3 weeks after upon exposure to the atmosphere. Each possibility is a separate embodiment.

According to some embodiments, the microcapsule is suitable for post-harvest treatment of crop. According to some embodiments, the microcapsule is capable of improving crop preservation. As used herein the term “post-harvest” refers to the stage of crop production immediately following harvest including storage and transport of the crop.

As used herein, the term “preservation” with regards to crop, refers to extending the amount of time passing between harvest of the crop to initiation of its decay. It is thus understood that, preservation of the crop extends its shelf-life, i.e. the length of time that it may be stored without becoming unfit for use or consumption.

As used herein the term “crop” refers to any cultivated plant, fungus, or alga that is harvested for food, clothing, livestock fodder, biofuel, medicine, or other uses. Each possibility is a separate embodiment. According to some embodiments, the crop is edible. According to some embodiments, the crop is grapes.

According to some embodiments the microcapsule may further include a surfactant selected from the group consisting of glyceryl monostearate, polyoxyethylene monooleate, polyoxyethylene monolaurate, polyoxyethylene sorbitan monolaurate, polyoxyethylene sorbitan monopalmitate, polyoxyethylene sorbitan monostearate, polyoxyethylene sorbitan tristearate, polyoxyethylene sorbitan monooleate, polyoxyethylene sorbitan trioleate, potassium oleate, polysorbate 20, polysorbate 40, polysorbate 80, sodium lauryl sulfate, sodium oleate, sorbitan monopalmitate, sorbitan monooleate, sorbitan monostearate, sorbitan tristearate, sorbitan trioleate, sorbitan monolaurate, triethanolamine oleate, and any combination thereof. Each possibility is a separate embodiment.

According to some embodiments, the microcapsule comprises less than about 5% by weight of the surfactant. According to some embodiments, the microcapsule comprises less than about 1% by weight of the surfactant. According to some embodiments, the microcapsule comprises less than about 0.5% by weight of the surfactant. According to some embodiments, the microcapsule comprises about 1%-5% by weight of the surfactant. According to some embodiments, the microcapsule comprises about 0.1%-0.5% by weight of the surfactant. According to some embodiments, the microcapsule comprises about 0.05%-0.5% by weight of the surfactant.

According to some embodiments, the microcapsule is contained within a container, such as but not limited to a sachet. According to some embodiments, the sachet may be made from woven fabric, non-woven fabric, or any other suitable material enabling the selective passage of vapors but impermeable to the microcapsules.

According to some embodiments, each sachet includes a plurality of the microcapsules disclosed herein. As used herein, the term plurality with regards to the number of microcapsules may include more than 100, more than 1000 or more than 5000 microcapsules per sachet. According to some embodiments, a plurality of microcapsule refers to the number of microcapsules required to reach a predetermined concentration of essential oil per sachet, such as for example about 10 gram essential oil per sachet, about 5 gram essential oil per sachet, about 2 gram essential oil per sachet, about 1 gram essential oil per sachet, about 0.5 gram essential oil per sachet, about 0.1 gram essential oil per sachet, about 0.05 gram essential oil per sachet or any other suitable amount of essential oil within the range of about 0.05-10 gram or about 0.05-5 gram of essential oil per sachet. Each possibility is a separate embodiment.

According to some embodiments, the sachets have a homogeneous content of microcapsules. As used herein the term “homogeneous content” refers to sachets including microcapsules containing the same essential oil or the same mixture of essential oils. A non-limiting example of a homogeneous sachet is a sachet including microcapsule encapsulating tea tree oil. Another non-limiting example of a homogeneous sachet is a sachet including microcapsule encapsulating tea tree oil and spearmint oil. According to some embodiments, the sachet may have a heterogeneous content of microcapsules. As used herein the term “heterogeneous content” refers to sachets including more than one type of microcapsules. A non-limiting example of a heterogeneous sachet is a sachet including microcapsules encapsulating caraway oil and microcapsules encapsulating tea tree oil. Another non-limiting example of a heterogeneous sachet is a sachet including microcapsules encapsulating caraway and spearmint oil and microcapsules encapsulating tea tree oil.

According to some embodiments, the sachet may be sealed, vacuum packed or otherwise enclosed so as to prevent evaporation of the essential oil prior to application. According to some embodiments, more than about 95% of the essential oil is retained within the microcapsule during 1 month, 2 months, 3 months, 6 months or 1 year of storage, prior to unsealing the sachet. Each possibility is a separate embodiment. According to some embodiments, about 20% to 90%, about 20% to 50%, about 30% to 90%, about 30-% to 80%, about 30% to 60%, about 30% to 50%, about 40% to 90%, about 40-% to 80%, about 40% to 60%, about 40% to 50%, about 50% to 90%, about 50% to 85%, or about 50% to 80%, of the essential oil is retained in the microcapsule for 3 weeks after unsealing of the sachet.

According to some embodiments, the microcapsule is tailored to obtain a desired release:retention ratio for example by changing the RPM of the homogenizer or the stirrer, by changing the volume of the aqueous solution, by changing the amount of surfactant added or the like. As a non-limiting example, the microcapsule may be tailored to have a release profile suitable for transport, i.e. the essential oil is released at an essentially even concentration within 2 days, 3 days, 5 days or a week. Each possibility is separate embodiment. As another non-limiting example, the microcapsule may be tailored to be suitable for long-term storage, i.e. the essential oil is released at an essentially even concentration along a period of 1 week or more, 2 weeks or more, 1 month or more, 2 months or more, 6 months or more and the like. Each possibility is separate embodiment.

According to some embodiments, the sachet (or other container) is sized and shaped to fit within a package and/or net of grapes. According to some embodiments, the sachet is suitable for use by the end consumer. According to some embodiments, the sachet, when unsealed and positioned in proximity to the grapes preserves the grapes and/or inhibits their decay. It is thus understood that the sachet disclosed herein may pro-long the shelf life of the grapes during storage by producer, during transport and/or during storage once purchased by the consumer. Each possibility is a separate embodiment. According to some embodiments, the sachet, when unsealed and placed in proximity to the grapes, inhibits decay by at least about 95%, at least about 90%, at least about 80% at least about 75%, when stored at 4° C. for 1 month. Each possibility is a separate embodiment. According to some embodiments, the sachet, when unsealed and placed in proximity to the grapes, inhibits decay by at least about 95%, at least about 90%, at least about 80% at least about 75%, when stored at 4° C. for 2 months. Each possibility is a separate embodiment. According to some embodiments, the sachet, when unsealed and placed in proximity to the grapes, inhibits decay by at least about 95%, at least about 90%, at least about 80% at least about 75%, when stored at 4° C. for 6 months. Each possibility is a separate embodiment.

According to some embodiments, there is provided a fruit and/or vegetable storage container having at least one pocket configured to contain therein at least one sachet comprising the microcapsules disclosed herein.

According to some embodiments, the container is suitable for home-storage of fruits and/or vegetables.

According to some embodiments, the pocket prevents direct contact between the sachet and the grapes.

According to some embodiments, the pocket may be made from a woven fabric, a non-woven fabric a, a knitted fabric or any other suitable material configured to confine the sachet within the pocket, but to allow passage of the essential oil vapors, in an essentially undisturbed manner. According to some embodiments, the number of pockets and/or their size and shape is determined based on the size of the container and/or the grape content. According to some embodiments, the number of pockets and/or their size and shape may be fit to include the number of sachets required to obtain optimal inhibition of grape decay. As a non-limiting example, the container may be configured to contain about 2 kg of grapes and have four pockets. As another non-limiting example, the container may be configured to contain about 2 kg of grapes and have five pockets. According to some embodiments, each pocket is sized and shaped to include a single sachet only. According to some embodiments, each pocket is sized and shaped to include a sachet with about 1-1000 gram, 0.5-100 gram, 0.5-50 gram, 0.5-20 gram, 0.5-10 gram, 0.5-5 gram, 1-50 gram, 1-20 gram, 1-10 gram, 1-5 gram of the microcapsules encapsulating an essential oil (e.g. tea tree oil), disclosed herein. Each possibility is a separate embodiment. According to some embodiments, each pocket is sized and shaped to include a sachet with a content of microcapsules providing about 0.1-20 gram, 0.1-10 gram, 0.5-20 gram, 0.5-10 gram, 0.5-5 gram, 1-50 gram, 1-20 gram, 1-10 gram, 1-5 gram of the essential oil per sachet. Each possibility is a separate embodiment.

According to some embodiments, the pockets may be distributed at various locations of the containers inner wall, e.g. at its bottom, at its side and/or at its lid. Each possibility is a separate embodiment.

According to some embodiments, the container may be disposable. According to some embodiments, the container may be for multiple uses.

According to some embodiments, the container may be pre-loaded with a suitable number of sachets within its pockets. According to some embodiments, the sachets within the container may be sealed. According to some embodiments, the container may include a cover, or other suitable means for sealing off the pockets and thus the sachets therein. According to some embodiments, the container may foldable. According to some embodiments, the container, when in its unfolded configuration may be vacuum packed in its entirety. According to some embodiments, once opened and/or unfolded, the sachets are unsealed and release of the essential oil from the microcapsules is commenced.

According to some embodiments, there is provided a method for inhibiting decay of grapes, the method comprising exposing grapes to a plurality of the microcapsules comprising a wax encapsulating an essential oil, as disclosed herein.

According to some embodiments, the essential oil is selected from the group consisting of angelica oil, anise oil, basil oil, bay oil, bergamot oil, bois de rose oil, calendula oil cananga oil, caraway oil, cardamom oil, cedar oil, cedarwood oil, chamaecyparis obtusa oil, chamomile oil, cinnamon oil, citronella oil, clary sage oil, clove oil, copaiba balsam oil, coriander oil, cumin oil, dill seed oil, eucalyptus globulus oil, eucalyptus radiate oil, fennel oil, garlic oil, geranium oil, ginger oil, grapefruit oil, guaiacwood oil, hiba oil, ho camphor oil, iris oil, Japanese mint oil, jasmine oil, lavender oil, laurel leaf oil, lemon oil, lemongrass oil, lime oil, linaloe oil, lindera oil, marjoram oil, mandarin peel oil, mustard oil, neroli oil, niaouli oil, onion oil, orange oil, oregano oil, palmarosa oil, parsley oil, patchouli oil, peach kernel oil, pennyroyal oil, pepper oil, peppermint oil, perilla oil, Peru balsam oil, petitgrain oil, pine needle oil, rose oil, rosemary oil, sandalwood oil, spearmint oil, star anis oil, tagetes oil, tea tree oil, tea seed oil, thyme oil, tolu balsam oil, tuberose oil, turmeric oil, vetivert oil, western mint oil, white micromeria oil, wintergreen oil, combinations and/or derivatives thereof. Each possibility is a separate embodiment. According to some embodiments, the essential oil is tea tree oil.

According to some embodiments, inhibiting the decay of grapes comprises inhibiting fungal infection of the grapes, in particular fungal infections caused by gray mold (Botrytis cinerea). According to some embodiments, the decay of the grapes is inhibited by at least 60%, 70%, 80% or 90%, when stored at 6-8° C. for approximately three weeks. Each possibility is a separate embodiment.

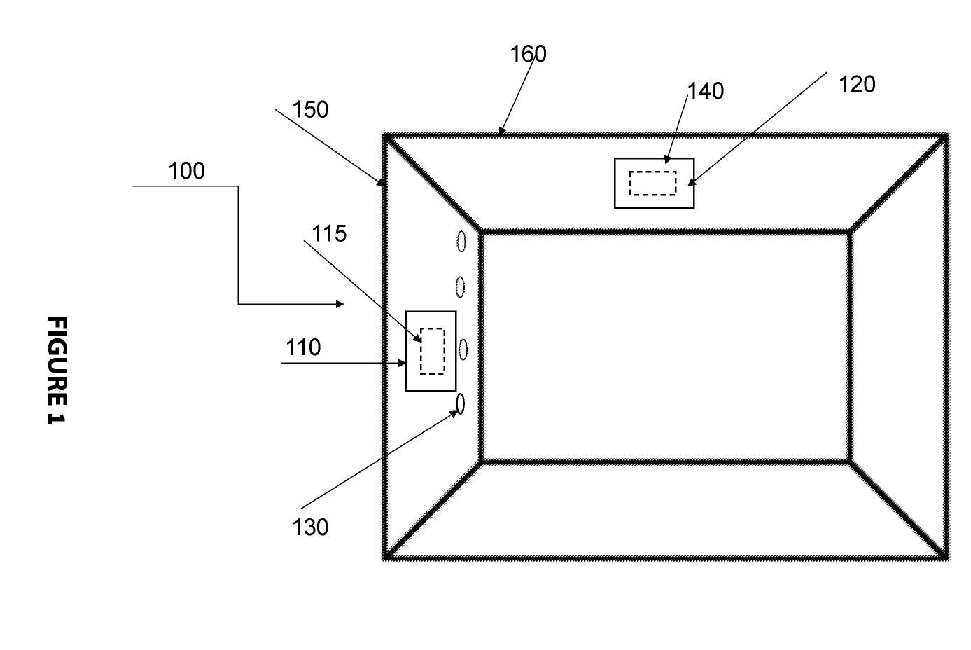

Reference in now made to FIG. 1, which schematically illustrates a storage container 100 (e.g. for grapes), according to some embodiments. Storage container 100 has a size and shaped configured to contain at least 1 kg of grapes. Storage container 100 includes pockets, here illustrated as pockets 110 and 120, on an inner side of walls 150 and 160. Pockets 110 and 120 are sized and shaped to contain a microcapsule containing sachets, such as sachet 115, as essentially described herein. It is understood to one of ordinary skill in the art, that storage container 100 may include additional pockets. It is further understood that the position of the pockets 110 and 120 within the storage container is illustrative only and that other positions are also applicable and thus within the scope of this disclosure. Optionally, storage container 100 may include a lid (not shown) configured to close storage container. As a further option, storage container 100 may include holes in its wall, here illustrated as holes 130 in wall 150 allowing ambient air to enter storage container 100. Alternatively, storage container 100 may include a netted window allowing ambient air to enter (option not shown). According to some embodiments, pockets 110 and 120 are sealed off by a seal and/or cover, here illustrated as seal 140 sealing off pocket 120, prior to use. When desired, for example when storage container 100 is filled with grapes, seal 140 may be removed thereby initiating release of the essential oil from the microcapsules, as essentially described herein.

The terms “comprises”, “comprising”, “includes”, “including”, “having” and their conjugates, as used herein, mean “including but not limited to”. The terms “comprises” and “comprising” are limited in some embodiments to “consists” and “consisting”, respectively. The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure. In the description and claims of the application, each of the words “comprise” “include” and “have”, and forms thereof, are not necessarily limited to members in a list with which the words may be associated.

As used herein, the singular form “a”, “an” and “the” include plural references unless the context clearly dictates otherwise. For example, the term “a compound” or “at least one compound” may include a plurality of compounds, including mixtures thereof.

As used herein the term “about” refers to plus/minus 10% of the value stated.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure.

The following examples are presented in order to more fully illustrate some embodiments of the invention. They should, in no way be construed, however, as limiting the broad scope of the invention.

### EXAMPLES

### Example 1—Encapsulation of Caraway Oil by Melt Dispersion

1000 g of water, 2 g of Polysorbate 20 (Tween 20) and 2 g of Sorbitan monopalmitate (Span 40) were added to a 3 L beaker and stirred while heating, until the surfactants were dissolved. To the hot solution, 260 g of Carnauba wax was added and stirring continued at 95° C., until the wax was melted. Upon complete melting of the carnauba wax, 65 g of caraway oil was added during vigorous stirring. After approximately 5 min and during continuous stirring, 1000 g of ice water was added and the beaker was removed from hot plate. The dispersion was then filtered, and the capsules collected. The collected capsules were subsequently rotated in a rotating drum together with silica gel beads to further dry. The capsules were finally separated from the silica beads using a sifter. A similar process was used to obtain microcapsules containing tea tree oil instead of the caraway oil.

### Example 2—Determination of the Release Profile of the Essential Oil from the Microcapsule

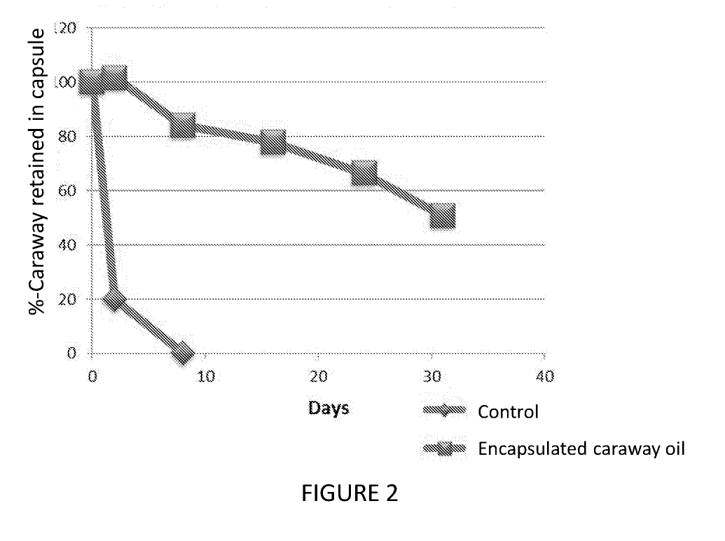

The amount of encapsulated essential oil, here caraway oil, (encapsulated as described in Example 1) was determined by dissolving 0.05-0.15 gram of microcapsule powder in 25 mL ethanol to extract the essential oil from the microcapsule. The concentration of the essential oil in the sample was determined at day 0 after production (indicative of encapsulation efficiency), and at days 2, 8, 16, 22 and 31 after production of the microcapsule, using standard HPLC techniques. The results were compared to an emulsion of non-encapsulated caraway oil. As seen from FIG. 2, whereas in the control experiment, essentially no caraway oil was left 10 days after preparation of the emulsion, the microcapsules disclosed herein retained approximately 50% of its caraway oil content for more than 30 days after production of the microcapsule. This clearly shows that the microcapsules disclosed herein have an advantageous release profile, which ensure that an optimal ratio between release and retention is achieved.

### Example 3—Inhibition of Grape Decay by Melt Dispersion Formed Essential Oil Containing Microcapsules

The experiment was conducted with grapes of an “Early Sweet” variety. After harvest, the grapes were stored for 24 hours at 20° C. without treatment, and subsequently delivered to a packing facility.

For the experiment, 5 Kg of grapes were placed in container boxes for storage. The grapes were either left untreated (Box 1), treated by placing a sachet containing microencapsulated tea-tree oil (2.5 g active ingredient—prepared as described in Example 1 herein) on top of the grapes (Box 2), treated by placing a sachet containing microencapsulated caraway oil (2.5 g active ingredient—prepared as described in Example 1 herein) on top of the grapes (Box 3), or treated by placing sulfur containing cloths on the grapes (Box 4). Each box was placed into a non-porous plastic bag and stored at 6-8° C. for 23 days.

After 23 days, the bags were opened and the grapes evaluated for gray mold infection. The percentage of the upper surface area infected with fungi was estimated. Evaluation of the amount of decay on each cluster was conducted separately for each of the two layers of grapes in each box, according to the following scale: 0)—without decay, 1) 1-3 decayed grapes, 2) 4-6 decayed grapes, 3) 7-10 decayed grapes, 4) 11-14 decayed grapes, 5) more than 14 decayed grapes per cluster. The amount of decay of the grape clusters is expressed as a decay index, based on a sample of the first 6 clusters evaluated from each layer in each box. The decay index for each layer was calculated according to the following formula:

Index=0*number of healthy clusters+1*number of clusters with decay degree 1+2*number of clusters with decay degree 2, 3*number of clusters with decay degree 3+4*number of clusters with decay degree 4+5*number of clusters with decay degree 5. (The maximal index with severe decay on all clusters is 30).

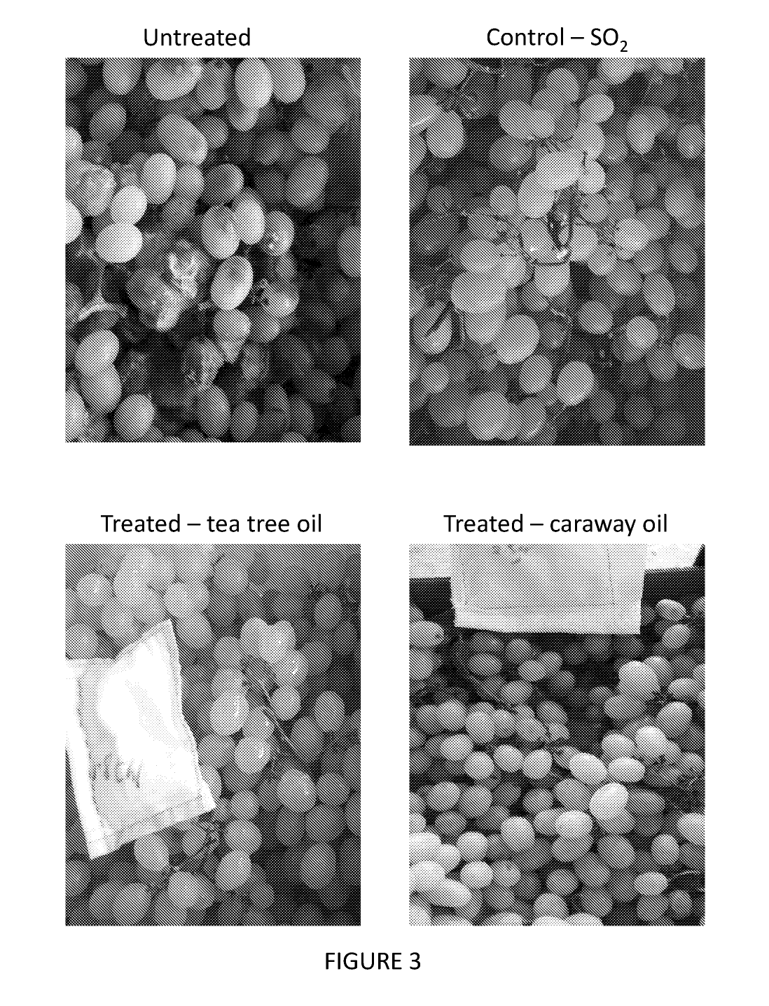

The results are summarized in tables 1 and 2 below and representative images shown in FIG. 3.

TABLE 1
Evaluation of decay on surface of grapes

| Box No. | Treatment | % decay |
|---|---|---|
| 1 | Untreated | 28.40 |
| 2 | Tea tree | 2.00 |
| 3 | Caraway | 7.00 |
| 4 | SO₂ pad | 5.25 |

TABLE 2
Evaluation of decay severity on grape clusters

| | | Decay index | Decay index |
|---|---|---|---|
| | Treatment | top layer | bottom layer |
| 1 | Untreated | 16.00 | 16.40 |
| 2 | Tea-Tree | 4.00 | 6.00 |
| 3 | Caraway | 8.25 | 10.75 |
| 4 | SO₂ pad | 5.25 | 13.25 |

As seen from Tables 1 and 2 and from FIG. 3, storage of the grapes with sachets containing carnauba wax encapsulated tea tree oil or caraway oil almost eliminated the decay of the grapes and the decay was much less severe, as compared to untreated. Surprisingly, the storage of the grapes with sachets containing carnauba wax encapsulated tea tree oil proved more effective than storage with the commercially available Sulphur (SO₂) pads.

The grapes were further evaluated for phytotoxicity (0—no phytotoxicity, 5—severe phytotoxicity) and for infection with Rhizopus. The results are presented in table 3 below

TABLE 3
Evaluation of phytotoxicity and Rhizopus infection

| | | | Rhizopus infection |
|---|---|---|---|
| | | | (boxes with Rhizopus |
| Box | | | infection/ |
| No. | Treatment | Phytotoxicity of grapes (0-10) | boxes evaluated) |
| 1 | Untreated | 0.00 | 3/5 |
| 2 | Tea tree | 0.50 | 2/4 |
| 3 | Caraway | 2.5000. | 2/4 |
| 4 | SO₂ pad | 1 | 4/4 |

As seen from table 3, the treatment of the grapes with sachets containing carnauba wax encapsulated tea tree oil had almost no phytotoxic effect and proved safer for use than the commercially available SO₂ pad. The phytotoxic effect of caraway oil, albeit higher, was also low. Moreover, treatment of the grapes with sachets containing carnauba wax encapsulated tea tree oil or caraway oil also inhibited Rhizopus infection; an effect that was not achieved by the commercially available SO₂ pad.

1.-23. (canceled)

24. A microcapsule comprising a wax encapsulating an essential oil,
wherein the wax is a naturally occurring wax having a melting point above 60° C., the microcapsule comprises 5-25% by weight of the essential oil, the microcapsule has a diameter of 5-1000 microns and the microcapsule is a matrix type microcapsule in which the essential oil is distributed uniformly within the wax.

25. The microcapsule of claim 24, wherein the microcapsule is devoid of support material.

26. The microcapsule of claim 24, wherein the essential oil is selected from the group consisting of tea tree oil, angelica oil, anise oil, basil oil, bay oil, bergamot oil, bois de rose oil, calendula oil cananga oil, caraway oil, cardamom oil, cedar oil, cedarwood oil, chamaecyparis obtusa oil, chamomile oil, cinnamon oil, citronella oil, clary sage oil, clove oil, copaiba balsam oil, coriander oil, cumin oil, dill seed oil, eucalyptus globulus oil, eucalyptus radiate oil, fennel oil, garlic oil, geranium oil, ginger oil, grapefruit oil, guaiacwood oil, hiba oil, ho camphor oil, iris oil, Japanese mint oil, jasmine oil, lavender oil, laurel leaf oil, lemon oil, lemongrass oil, lime oil, linaloe oil, lindera oil, marjoram oil, mandarin peel oil, mustard oil, neroli oil, niaouli oil, onion oil, orange oil, oregano oil, palmarosa oil, parsley oil, patchouli oil, peach kernel oil, pennyroyal oil, pepper oil, peppermint oil, perilla oil, Peru balsam oil, petitgrain oil, pine needle oil, rose oil, rosemary oil, sandalwood oil, spearmint oil, star anis oil, tagetes oil, tea tree oil, tea seed oil, thyme oil, tolu balsam oil, tuberose oil, turmeric oil, vetivert oil, western mint oil, white micromeria oil, wintergreen oil, combinations and/or derivatives thereof.

27. The microcapsule of claim 26, wherein the essential oil is tea tree oil.

28. The microcapsule of claim 24, wherein 20% to 90% of the essential oil is retained in the microcapsule for 3 weeks upon exposure to the atmosphere.

29. The microcapsule of claim 28, wherein 40% to 85% of the at least one essential oil is retained in the microcapsule for 3 weeks after application to a substrate.

30. The microcapsule of claim 24, wherein the natural wax is selected from the group consisting of carnauba wax, candelilla wax, beeswax, cocoa butter, montan wax, rice bran wax, sugar cane wax and any combination thereof.

31. The microcapsule of claim 30, wherein the natural wax is carnauba wax.

32. The microcapsule of claim 24, wherein the microcapsule comprises 10-25% by weight of the essential oil.

33. The microcapsule of claim 24, wherein the natural wax is devoid of chemical modifications.

34. The microcapsule of claim 24, further comprising a surfactant selected from the group consisting of glyceryl monostearate, polyoxyethylene monooleate, polyoxyethylene monolaurate, polyoxyethylene sorbitan monolaurate, polyoxyethylene sorbitan monopalmitate, polyoxyethylene sorbitan monostearate, polyoxyethylene sorbitan tristearate, polyoxyethylene sorbitan monooleate, polyoxyethylene sorbitan trioleate, potassium oleate, polysorbate 20, polysorbate 40, sodium lauryl sulfate, sodium oleate, sorbitan monopalmitate, sorbitan monooleate, sorbitan monostearate, sorbitan tristearate, sorbitan trioleate, sorbitan monolaurate, triethanolamine oleate, and any combination thereof.

35. The microcapsule of claim 24, wherein the microcapsule comprises 0.1-0.5% by weight of the surfactant.

36. The microcapsule of claim 24 having a diameter of 10-500 microns.

37. The microcapsule of claim 36 having a diameter of 100-300 microns.

38. A method for inhibiting decay of grapes, the method comprising exposing grapes to a plurality of the microcapsules of claim 27.

39. The method of claim 38, wherein grape decay is inhibited by at least 80% when stored at 6-8° C. for three weeks.

40. A sachet sealed in an airtight package comprising a plurality of microcapsules comprising a wax encapsulating an essential oil,
wherein the wax is a naturally occurring wax having a melting point above 60° C., the microcapsules comprise 12-25% by weight of the essential oil, the microcapsules are matrix type microcapsules in which the essential oil is uniformly distributed within the wax and the microcapsules have an average diameter of 5-1000 microns.

41. The sachet of claim 40, wherein 20% to 90% of the essential oil is retained in the microcapsule for 3 weeks after unsealing of the sachet.

42. The sachet of claim 40, wherein the essential oil comprises tea tree oil.

43. The sachet of claim 40, wherein the microcapsules are devoid of support material.
